(19) United States
(12) Patent Application Publication
(10) Pub. No.: US 2017/0101855 A1
(43) Pub. Date: Apr. 13, 2017

(54) DEBRIS TOLERANT FLEXIBLE ELEMENT VALVE

(71) Applicant: Schlumberger Technology Corporation, Sugar Land, TX (US)

(72) Inventors: Malcolm Atkinson, Missouri City, TX (US); Gary L. Rytlewski, League City, TX (US); Rachel Deghuee, Pearland, TX (US); Laurent Alteirac, Missouri City, TX (US)

(21) Appl. No.: 15/291,412

(22) Filed: Oct. 12, 2016

Related U.S. Application Data
(60) Provisional application No. 62/240,481, filed on Oct. 12, 2015.

(51) Int. Cl. E21B 43/12; E21B 34/08; F16K 15/18; E21B 29/08; E21B 41/00; E21B 33/064; E21B 34/10

(52) U.S. Cl. CPC E21B 43/12; E21B 33/064; E21B 34/08; E21B 34/10; E21B 29/08; E21B 41/0007; F16K 15/185; E21B 43/267

(57) ABSTRACT

A technique facilitates fluid flow control with respect to a fluid flowing through a component of a landing string by avoiding or protecting mechanisms otherwise susceptible to debris. A valve is provided in a well component of a landing string and comprises a flexible element. The flexible element is oriented for flexing in an inward direction with respect to an internal flow passage through the landing string. The flexible element enables selective closing off of the internal flow passage without exposing certain types of mechanical mechanisms to fluid flowing through the landing string.

### BACKGROUND

Valves are employed in many types of systems and applications for controlling fluid flow. For example, a variety of ball valves and flapper valves can be employed in subsea landing strings. Subsea landing strings may comprise various landing string components which are at least partially received within a blowout preventer stack. Once deployed, the subsea landing string may extend from within the blowout preventer stack and up to, for example, a first standard riser joint. The subsea landing string may be used to facilitate various servicing operations, including completion operations, testing operations, e.g. flow testing operations, intervention operations, and/or other well related operations. The ball valves and/or flapper valves are used to control flow, e.g. block flow, along an internal flow passage of the subsea landing string during certain stages of the operation or upon the occurrence of certain events. However, current valves utilize mechanical mechanisms with sliding or rotating surfaces which can be susceptible to damage and jamming when debris, e.g. sand, is present in the well effluent or injected fluids.

### SUMMARY

In general, a system and methodology are provided for controlling fluid flow through a component of a landing string while protecting mechanisms and/or enabling elimination of mechanisms otherwise susceptible to debris carried by fluids flowing through the landing string. A valve is provided in a well component of a landing string and comprises a flexible element. The flexible element is oriented for flexing in an inward direction with respect to an internal flow passage through the landing string. The flexible element enables selective closing off of the internal flow passage with reduced exposure of mechanical mechanisms to fluid flowing through the landing string.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a well system in which a subsea landing string is being landed into corresponding well equipment at a subsea location, according to an embodiment of the disclosure;

FIG. 2 is a schematic illustration of an example of a valve system employing a flexible element which enables selective closing of a flow passage through a landing string, according to an embodiment of the disclosure;

FIG. 3 is a cross-sectional view of the valve system illustrated in FIG. 2, according to an embodiment of the disclosure;

FIG. 4 is a schematic illustration similar to that of FIG. 2 but showing the valve system in a closed configuration, according to an embodiment of the disclosure;

FIG. 5 is a cross-sectional view of the closed valve system illustrated in FIG. 4, according to an embodiment of the disclosure;

FIG. 6 is a schematic illustration of another example of a valve system employing a flexible element which enables selective closing of a flow passage through a landing string, according to an embodiment of the disclosure; and

FIG. 7 is another schematic illustration of the valve system shown in FIG. 6 in which the valve system is in a closed configuration, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally relates to a system and methodology which facilitate control with respect to flowing fluids potentially containing debris, e.g. sand/proppant. The technique effectively protects and/or enables elimination of various mechanical valve mechanisms otherwise susceptible to detrimental effects caused by the debris. The system and methodology are useful in landing strings, e.g. subsea landing strings, and other well related equipment. The approach enables reduction in the number of mechanical components or protection of mechanical components by utilizing a flexible element for controlling, e.g. blocking, fluid flow along an internal passage of the landing string.

According to an embodiment, a valve is provided in a well component of a landing string and comprises the flexible element. By way of example, the flexible element may be in the form of a flexible tube element disposed along an internal flow passage of a landing string, e.g. a subsea landing string. The flexible tube element may be disposed within a tubular structure defining the internal flow passage and/or may comprise a section of tubing defining the internal flow passage. In this example, the flexible element is oriented for flexing in an inward direction with respect to the internal flow passage through the landing string. The flexible element may be selectively flexed to enable closing off of the internal flow passage while protecting or enabling elimination of mechanical mechanisms otherwise exposed to fluid flowing through the landing string.

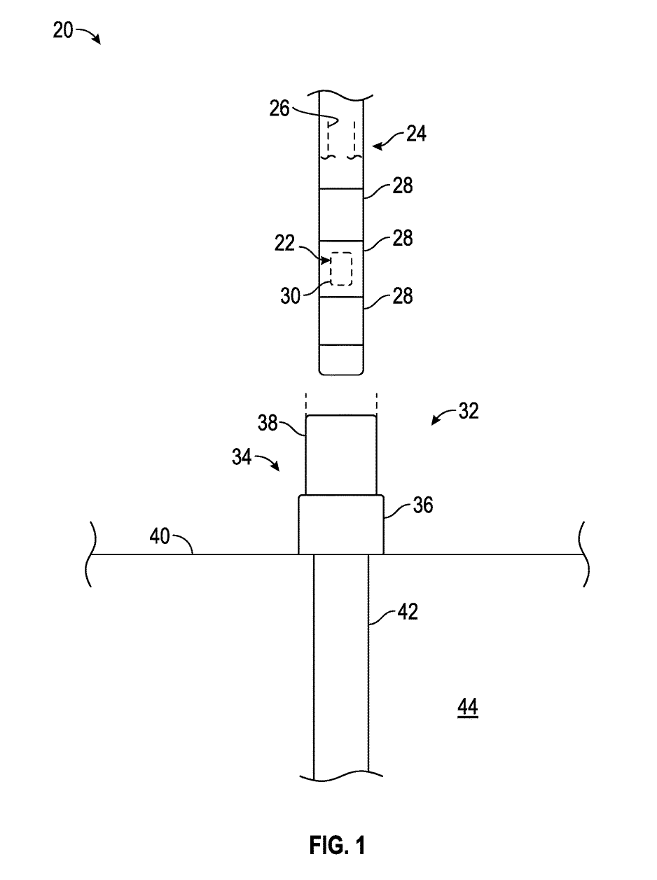

Referring generally to FIG. 1, an example of a well system 20 is illustrated as utilizing a flexible element valve system 22. In this embodiment, the well system 20 comprises a landing string 24, e.g. a subsea landing string, having an internal flow passage 26 extending generally axially through the landing string 24 to enable delivery of treatment fluids or flow of well fluids through the landing string 24. In this example, the landing string 24 comprises a plurality of subsea landing string well components 28 and at least one of the well components 28 may be in the form of (or may include) flexible element valve system 22. By way of example, well components 28 may comprise a subsea test tree, a tubing hanger running tool, various flow control valves, and/or other well components 28 depending on the parameters of a given application. In the illustrated embodiment, the flexible element valve system 22 comprises a flexible element valve 30, embodiments of which are described in greater detail below.

In the embodiment illustrated in FIG. 1, the landing string 24 is a subsea landing string which is moved to a subsea location 32 for engagement with subsea equipment 34. By way of example, the subsea equipment 34 may comprise a wellhead 36 and a blowout preventer (BOP) stack 38 although various additional and/or other types of equipment may be employed at subsea location 32 depending on the parameters of a given well application. The subsea equipment 24 may be positioned at a seabed 40 above a wellbore 42 drilled through various subsurface formations 44, e.g. hydrocarbon bearing formations.

In some applications, the subsea landing string 24 is inserted wholly or at least partially into the BOP stack 38 to perform various well testing and/or other well service operations. It should be noted that various risers and other equipment may be employed, and one or more flexible element valve systems 22 may be used along the landing string 24. In some applications, the flexible element valve or valves 30 may be used with other types of valves disposed along the landing string 24.

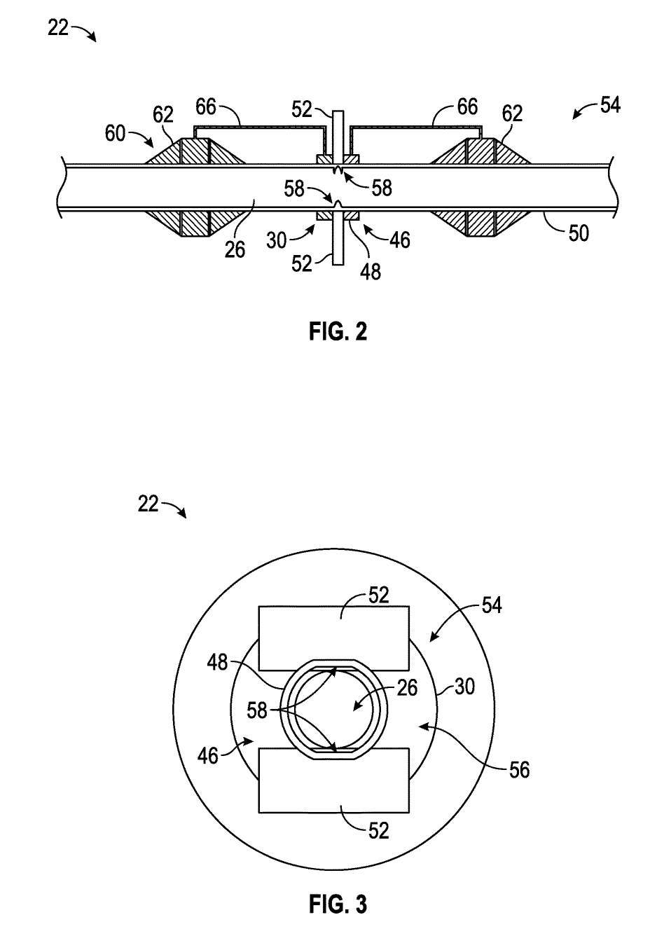

Referring generally to FIGS. 2 and 3, an embodiment of flexible element valve system 22 is illustrated with flexible element valve 30. In this example, the flexible element valve 30 comprises a flexible element 46 which may be in the form of a flexible tube element 48. The flexible tube element 48 is disposed along an interior, or forms part of, a tubular structure 50. The tubular structure 50 defines a portion of the internal flow passage 26 that extends through this particular well component 28. In many applications, the internal flow passage 26 is the primary flow passage extending generally axially through the overall landing string 24, e.g. subsea landing string. Depending on the application, the tubular structure 50 may be, for example, an independent section of tubing or a tubular interior of the corresponding well component 28.

The flexible element 46, e.g. flexible tube element 48, may be selectively flexed in an inward direction which moves the flexible material farther into an interior of the internal flow passage 26. Accordingly, the flexible element 46 may be constructed from a variety of flexible materials, e.g. elastomeric materials of the type used for packers or other equipment subjected to the temperatures and pressures of a well related environment. However, the flexible element 46 may be constructed from various composite materials or other materials which provide suitable flexibility and strength for closing off the internal flow passage 26 in subsea and/or well related environments.

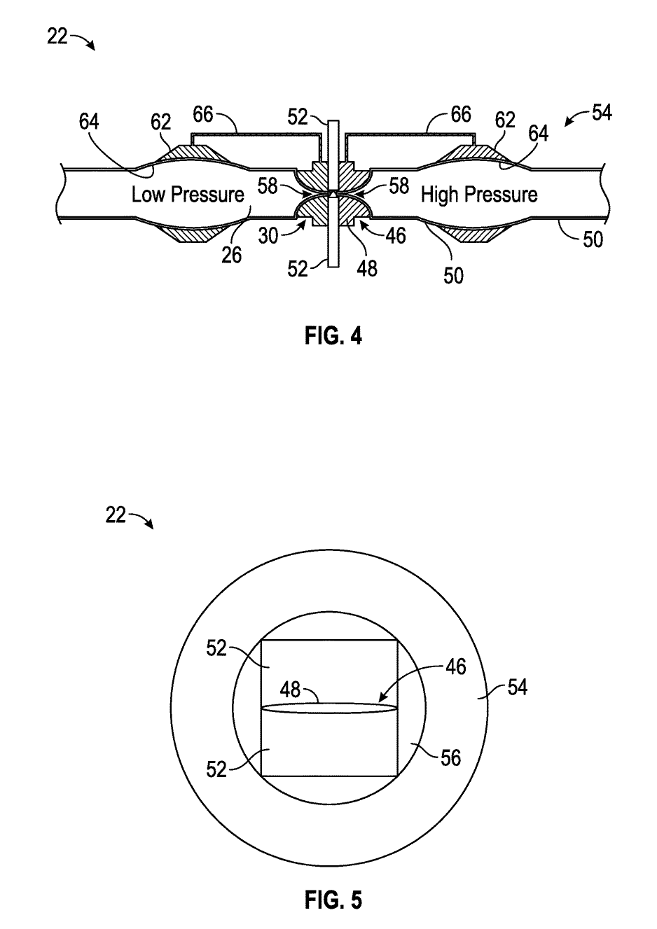

In this example, the flexible element 46 is selectively flexed inwardly via forces applied by a gate or gates 52. For example, a pair of gates 52 may be positioned on opposite sides of flexible tube element 48 and selectively shifted in a radially inward direction to close off the internal flow passage 26, as illustrated in FIGS. 4 and 5. As the gates 52 are shifted inwardly toward each other, the flexible tube element 48 is flexed inwardly until the flexible element valve 30 is closed and internal flow passage 26 is sealed with respect to fluid flow therethrough (see, for example, FIG. 5). The valve system 22 may be constructed with a supporting housing 54 which supports actuation of gates 52 and also defines a cavity 56 located so as to provide sufficient room for deflection of flexible tube element 48 as it is shifted from the open flow position illustrated in FIG. 3 to the closed flow position illustrated in FIG. 5. The gates 52, in turn, are constructed with sufficient width to ensure the flexible tube element 48 is collapsed completely when valve 30 is in the closed configuration.

Depending on the application, the gates 52 may be shifted mechanically, electromechanically, hydraulically, e.g. via a hydraulic piston, or by other suitable actuator mechanisms. In some applications, the gates 52 may comprise or may work in cooperation with cutting blades 58 which can be actuated to cut coiled tubing or wireline cable if present in the wellbore 42 when valve 30 is closed. For example, the cutting blades 58 may be integrated into, e.g. coupled to, metal support gates 52 to enable shearing of a conveyance, e.g. coil tubing, wireline, or slick line, extending along the internal flow passage 26. The shearing action may be used in an emergency disconnect situation. Depending on the application, the cutting blades 58 may be constructed to extend through the flexible tube element 48 and to interlock when closed to ensure sealing of valve 30. It should also be noted that flexible tube element 48 may comprise a single tube extending between the gates 52 or, in some applications, may comprise separate tube element sections coupled to gates 52. In some embodiments, the flexible element valve system 22 may be constructed to fail to a closed position closing off internal flow passage 26 given removal of hydraulic control pressures.

Referring again to FIGS. 2 and 4, the flexible element valve system 22 also may utilize a pressure compensation system 60. By way of example, the pressure compensation system 60 includes pressure compensators 62 to balance pressure across flexible element 46. The ability to balance pressure facilitates operation of the valve system 22 under high pressures.

In the embodiment illustrated, the pressure compensators 62 compensate for pressure differentials created by a low-pressure side and a high-pressure side of the gates 52. Each pressure compensator 62 may comprise a compensating bladder 64 (see FIG. 4), and the compensating bladders 64 work in cooperation with the actuatable gates 52 to help withstand pressure differentials across flexible element valve 30 when valve 30 is closed. As illustrated, each compensating bladder 64 may be placed in fluid communication with a corresponding side of flexible tube element 48 via a flow passage 66. Each flow passage 66 may be routed from the corresponding compensating bladder 64 to an external region of the flexible tube element 48 on the same axial side of the gates 52 as the corresponding compensating bladder 64.

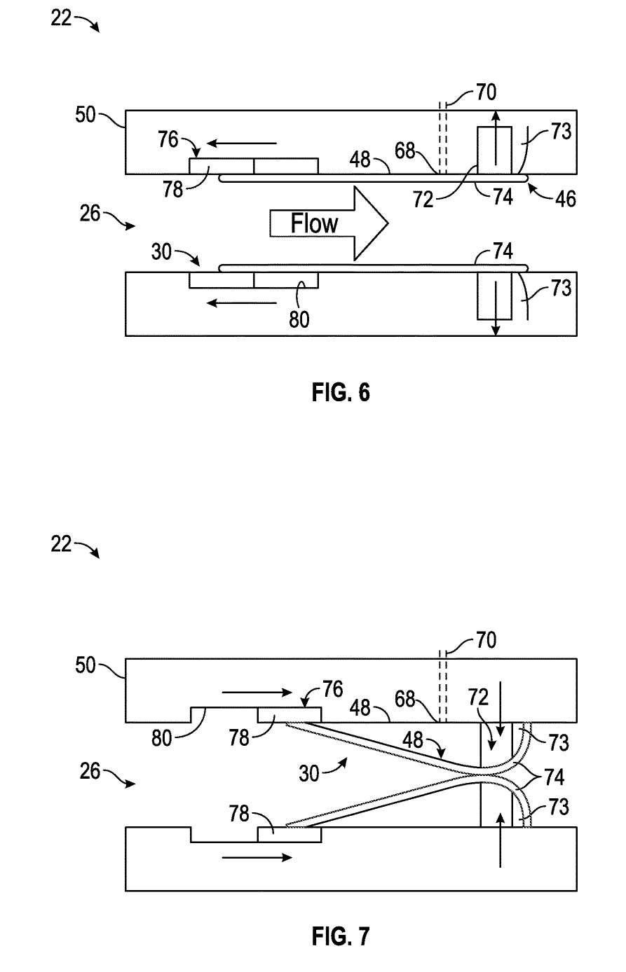

Referring generally to FIGS. 6 and 7, another embodiment of flexible element valve system 22 is illustrated. In this example, the flexible element 46 may again be in the form of a flexible tube element 48. By way of example, the flexible tube element 48 may be positioned along the interior of the tubular structure 50 defining internal flow passage 26. In an open configuration, as illustrated in FIG. 6, fluid is allowed to flow along the internal flow passage 26. However, the flexible tube element 48 is inflatable via fluid, e.g. hydraulic fluid, supplied through a port 68 in tubular structure 50. Depending on the application, the fluid used to inflate the flexible tube element 48 may be in the form of well fluid or other hydraulic fluid delivered under suitable pressure through, for example, a hydraulic control line 70.

The fluid pressure of fluid delivered through supply port 68 is used to inflate the flexible element 46 in an inward direction, e.g. a radially inward direction, to constrict the internal flow passage 26. As illustrated in FIG. 7, flexible tube element 48 may be inflated in an inward direction until internal flow passage 26 is closed off to block fluid flow. As with the embodiment illustrated in FIGS. 2-5, this embodiment also employs flexible element 46 to minimize the number of mechanical parts or to limit the number of mechanical parts exposed to debris which may be contained in well fluids flowing along internal flow passage 26.

By placing the flexible tube element 48 along an internal surface of tubular structure 50, the flexible tube element 48 and the sealing faces are generally tangential to flows of fluid through internal flow passage 26, thus reducing the potential for erosion damage. A wear resistant support structure 72, e.g. a metal support structure, may be located within the flexible tube element 48 and/or may be embedded in the flexible tube element 48. For example, the support structure 72 may comprise a plurality of metal structures 73 embedded in or otherwise supporting the flexible tube element 48 in a region proximate sealing faces 74, which is a region susceptible to substantially erosive effects.

The metal structures 73 or other support structure 72 also may be used to provide structural support to flexible element 46 to help withstand the differential pressures across flexible element valve 30 when the flexible element 46 is closed. In some applications, the support structure 72 may comprise structures 73 in the form of a plurality of solid wedges, e.g. metal wedges, which translate into the center of the flow path defined by internal flow passage 26. Other examples of support structure 72 include braided wire or cables which are embedded in elastomeric material used to form the flexible element 46. However, various other structures and materials may be used to protect and support the flexible element 46 against erosion and differential pressures.

To accommodate inflation of flexible element 46, the flexible element 46 may be formed as flexible tube element 48 with one end affixed to the tubular structure 50 and the other end affixed to a movable, e.g. slidable, element 76. As the flexible tube element 48 is inflated, the movable element 76 is moved by the corresponding end of the flexible tube element 48 to accommodate the inward expansion of the flexible tube element, as illustrated in FIG. 7. When the flexible tube element 48 is deflated, the movable element 76 allows the flexible tube element 48 to return to its open flow configuration, as illustrated in FIG. 6.

The movable element 76 may be constructed in various forms to accommodate the inflation and consequent flexing of the flexible tube element 48 in an inward direction. According to an example, the movable element 76 is in the form of a slidable ring 78 which is slidably captured within a corresponding recess 80. By way of example, the corresponding recess 80 may be formed along an internal surface of tubular structure 50. The slidable ring 78 may be shifted back and forth along the corresponding recess 80 by the flexible tube element 48 as the flexible tube element 48 is inflated and deflated to close and open valve 30.

The flexible element valve system 22 may be used in many types of subsea landing strings 24, other types of landing strings, and other types of well systems. The number and location of flexible element valves 30 also may be selected according to the parameters of a given well servicing application or other application. Similarly, the size and construction of each flexible element valve 30 may be adjusted to accommodate the specific application. Various types of flexible elements 46, e.g. flexible tube elements, may be employed with corresponding actuation mechanisms, e.g. hydraulic and/or mechanical actuation systems.

The flexible element 46 is located to reduce and/or protect dynamic metal components of the overall valve system. For example, the flexible element 46 may be used to reduce the number of metal mechanical components and/or to isolate metal mechanical components. Depending on the environment and the application, the flexible element 46 may be formed from an elastomeric material, an elastomeric composite material, or other suitable materials selected according to the conditions to which the flexible element valve 30 is subjected.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for use in a well, comprising:
a subsea landing string constructed for receipt in a blowout preventer stack, the subsea landing string comprising:
a tubular structure having an internal flow passage; and
a flexible tube element, the flexible tube element being selectively flexible in an inward direction to seal off the internal flow passage.

2. The system as recited in claim 1, further comprising a gate mechanism having at least one gate oriented to selectively flex the flexible tube element in the inward direction to seal off the internal flow passage.

3. The system as recited in claim 1, wherein the flexible tube element is inflatable to selectively flex the flexible tube element in the inward direction to seal off the internal flow passage.

4. The system as recited in claim 3, wherein the flexible tube element is inflated by well fluid.

5. The system as recited in claim 3, wherein the flexible tube element is inflated by hydraulic fluid supplied to the flexible tube element by a hydraulic line.

6. The system as recited in claim 3, wherein the flexible tube element is coupled with a sliding element which is slidably positioned along the internal flow passage to facilitate flexing of the flexible tube element in the inward direction during inflation of the flexible tube element.

7. The system as recited in claim 1, further comprising a support structure coupled with the flexible element.

8. The system as recited in claim 2, wherein a cutting blade is integrated with the gate mechanism to enable shearing of a conveyance disposed in the internal flow passage.

9. The system as recited in claim 1, further comprising a pressure balance system in fluid communication with the flexible tube element.

10. The system as recited in claim 1, wherein the flexible tube element is formed from an elastomeric material.

11. A method for controlling flow, comprising:
positioning a flexible element along an internal flow passage of a subsea landing string;
deploying the flexible element and the subsea landing string to a subsea location; and
enabling selective closing of the internal flow passage via flexing of the flexible element into an interior of the internal flow passage.

12. The method as recited in claim 11, wherein positioning comprises positioning a flexible tube element along the subsea landing string.

13. The method as recited in claim 11, wherein deploying comprises deploying the flexible element and the subsea landing string to a subsea blowout preventer stack.

14. The method as recited in claim 11, wherein enabling comprises positioning a plurality of gates for actuation in a direction which flexes the flexible element inwardly to close off the internal flow passage.

15. The method as recited in claim 11, wherein enabling comprises positioning an inflation flow port at a location which allows inflation of the flexible element inwardly to close off the internal flow passage.

16. The method as recited in claim 15, further comprising using a metal support structure to help hold the flexible element in an inflated configuration.

17. A system, comprising:
a well component of a subsea landing string, the well component having a valve comprising a flexible element oriented for flexing in an inward direction such that the inward flexing of the flexible element closes off an internal subsea landing string flow passage disposed through the well component.

18. The system as recited in claim 17, wherein the valve fails to a closed position and the flexible element is a tubular elastomeric element.

19. The system as recited in claim 17, further comprising an actuation system for selectively flexing the flexible element to a closed position, the actuation system comprising a mechanical actuation system.

20. The system as recited in claim 17, further comprising an actuation system for selectively flexing the flexible element to a closed position, the actuation system comprising a hydraulic actuation system.
